(19) United States
(12) Patent Application Publication
(10) Pub. No.: US 2005/0222711 A1
(43) Pub. Date: Oct. 6, 2005

(54) Robot and a robot control method

(75) Inventors: Takashi Yoshimi, Kanagawa-ken (JP); Kaoru Suzuki, Kanagawa-ken (JP); Daisuke Yamamoto, Kyoto-fu (JP); Junko Hirokawa, Kanagawa-ken (JP); Hideichi Nakamoto, Kanagawa-ken (JP); Masafumi Tamura, Tokyo (JP); Tomotaka Miyazaki, Kanagawa-ken (JP); Shunichi Kawabata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/091,418

(22) Filed: Mar. 29, 2005

(30) Foreign Application Priority Data
Apr. 1, 2004 (JP) 2004-109001

(51) Int. Cl. G06F 19/00

(52) U.S. Cl. 700/245

(57) ABSTRACT

A robot is autonomously moved locally by a move mechanism. In the robot, a check work memory stores a plurality of check works and check place to execute each check work in case of a user's departure to a remote location. A check work plan unit selects check works to be executed from the check work memory and generates an execution order of selected check works. A control unit controls the move mechanism to move the robot to a check place to execute a selected check work according to the execution order. A work result record unit records an execution result of each of the selected check works. A presentation unit presents the execution result to the user.

### CROSS-REFERENCE TO RELATED APPLICATIONS

This application is based upon and claims the benefit of priority from prior Japanese Patent Application P2004-109001, filed on Apr. 1, 2004; the entire contents of which are incorporated herein by reference.

### FIELD OF THE INVENTION

The present invention relates to a robot and a robot control method for supporting an indoor check work before a user goes out.

### BACKGROUND OF THE INVENTION

Recently, in order to monitor a person's home while he is away, a remote monitor camera and a caretaking robot are developed. For example, the remote monitor camera is disclosed in “Toshiba's network camera “IK-WB11”, Internet<URL:http://www.toshiba.co.jp/about/press/2003_{—}08/pr_j2501. htm>”. This remote monitor camera is connected to an Intranet or an Internet, and delivers a video to PC (Personal Computer) in real time. Furthermore, this robot camera can change direction in response to a remote operation from a PC browser screen.

The caretaking robot is disclosed in ““Development of a Home Robot MARON-1 (1)”, Y. Yasukawa et al., Proc. of the 20th Annual conference of the Robotics Society of Japan, 3F11, 2002”. A user can obtain an indoor video by remotely operating the indoor robot from outside. Furthermore, this robot automatically detects an unusual occurrence in the person's home while he is away and informs the user who went out of the unusual occurrence. In this way, in the remote monitor camera and the caretaking robot of the prior art, the aim is monitoring the person's home while he is away.

On the other hand, a home robot which is autonomously operable is disclosed in “Autonomous Mobile Robot “YAMABICO” by the University of Tsukuba, Japan, Internet<URL:http://www.roboken.esys.tsukuba.ac.jp/>”. The aim of this robot is autonomous execution of the robot's moving and the arm's operation.

However, these camera and robot (disclosed in above three references) can not support the user to previously prevent a crime or a disaster indoors. For example, when a burglar intrudes into the person's home while he is away, the user who went out can know the fact through the camera or robot. However, the camera and robot can not previously support prevention for intrusion of the burglar. Furthermore, for example, when a user left a thing in the house, the user who went out can check the thing in the house through above camera or the robot. However, these camera and robot can not previously support prevention for leaving the thing in the house.

### SUMMARY OF THE INVENTION

The present invention is directed to a robot and a robot control method for supporting various check works to be executed indoors before the user goes out.

According to an aspect of the present invention, there is provided a robot for autonomously moving locally, comprising: a move mechanism configured to move said robot; a check work memory configured to store a plurality of check works and check places to execute each check work in case of a user's departure; a check work plan unit configured to select check works to be executed from said check work memory and to generate an execution order of selected check works; a control unit configured to control said move mechanism to move said robot to a check place to execute a selected check work according to the execution order; a work result record unit configured to record an execution result of each of the selected check works; and a presentation unit configured to present the execution result to the user.

According to another aspect of the present invention, there is also provided a method for controlling a robot, comprising: storing a plurality of check works and check places to execute each check work locally in case of a user's departure in a memory; selecting check works to be executed from the memory; generating an execution order of selected check works; moving the robot to a check place to execute a selected check work according to the execution order; recording an execution result of each of the selected check works; and presenting the execution result to the user.

According to still another aspect of the present invention, there is also provided a computer program product, comprising: a computer readable program code embodied in said product for causing a computer to control a robot, said computer readable program code comprising: a first program code to store a plurality of check works and check places to execute each check work locally in case of a user's departure in a memory; a second program code to select check works to be executed from the memory; a third program code to generate an execution order of selected check works; a fourth program code to move the robot to a check place to execute a selected check work according to the execution order; a fifth program code to record an execution result of each of the selected check works; and a sixth program code to present the execution result to the user.

### BRIEF DESCRIPTION OF THE DRAWINGS

FIG. 1 is a block diagram of a robot 100 according to a first embodiment.

FIG. 2 is a schematic diagram of a component of a check work plan unit 60 according to the first embodiment.

FIG. 3 is a schematic diagram of a concrete example of the check work plan unit 60 according to the first embodiment.

FIG. 4 is a flow chart of processing of the robot 100 according to the first embodiment.

FIG. 5 is a schematic diagram of a check result as an image according to the first embodiment.

FIG. 6 is a schematic diagram of the check result as a list according to the first embodiment.

FIG. 7 is a schematic diagram of a concrete example of the check work plan unit 60 according to a second embodiment.

FIG. 8 is a flow chart of processing of the robot 100 according to the second embodiment.

FIG. 9 is a schematic diagram of a concrete example of the check work plan unit 60 according to a third embodiment.

FIG. 10 is a flow chart of processing of the robot 100 according to the third embodiment.

### DETAILED DESCRIPTION OF THE EMBODIMENTS

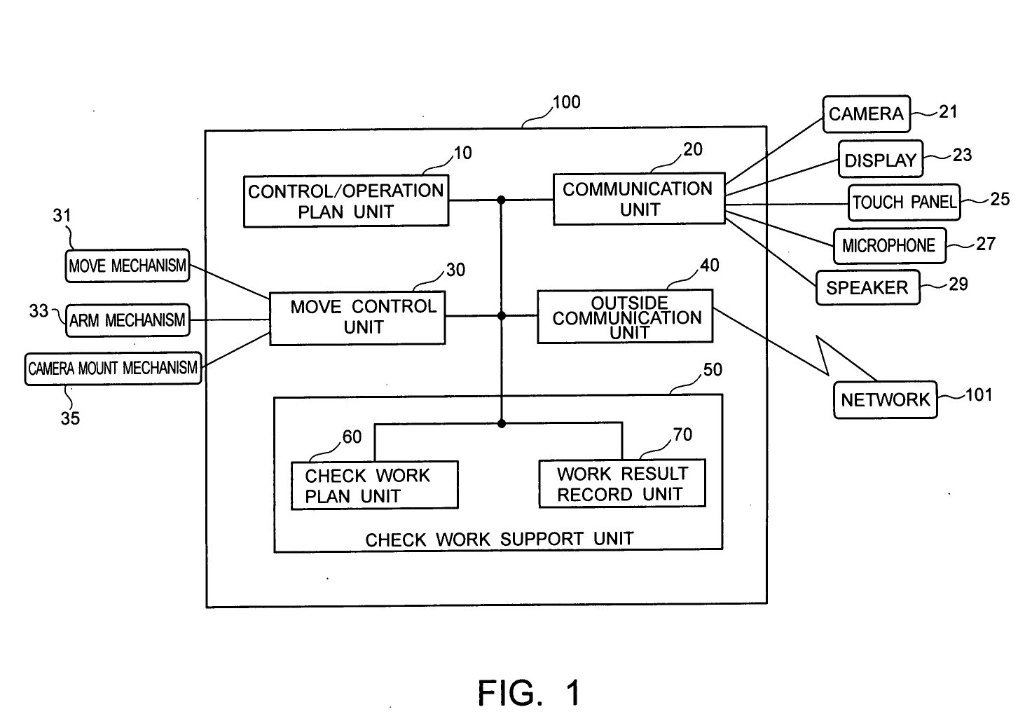

Hereinafter, various embodiments of the present invention will be explained by referring to the drawings. FIG. 1 is a block diagram of a robot 100 for supporting a departing or remote user according to a first embodiment. The robot 100 includes a control/operation plan unit 10, a communication unit 20, a move control unit 30, an outside communication unit 40, and a check work support unit 50. Furthermore, the communication unit 20 connects with a camera 21, a display 23, a touch panel 25, a microphone 27, and a speaker 29. The move control unit 30 connects with a move mechanism 31, an arm mechanism 33, and a camera mount mechanism 35.

The control/operation plan unit 10 controls each unit of the robot 100, and plans a work operation of the robot 100. For example, the control/operation plan unit 10 stores map information as the robot's movable area, and generates a move route of the robot 100 based on the map information. As a result, the robot 100 can autonomously move indoors.

The communication unit 20 receives a user's speech or indication from an input/output device, and presents information to the user. For example, the communication unit 20 receives the user's image through the camera 21, speech through the microphone 27, or indications through the touch panel 25. Furthermore, the communication unit 20 presents an image through the display 23 or speech through the speaker 29. As a result, the robot 100 can receive the user's indication and present information to the user.

The move control unit 30 controls the move mechanism 31, the arm mechanism 33, and the camera mount mechanism 35. For example, the move control unit 30 moves the robot 100 to a destination according to a route generated by the control/operation plan unit 10, and controls the move mechanism 31 or the arm mechanism 33 in order for the robot 100 to work. Furthermore, the move control unit 30 controls the camera mount mechanism 35 in order for the camera 21 to turn to a desired direction or to move to a desired height.

The outside communication unit 40 sends/receives necessary information through a network 101. For example, the outside communication unit 40 sends/receives data with an outside device through an Internet, such as a wireless LAN, or sends/receives information through an Intranet network.

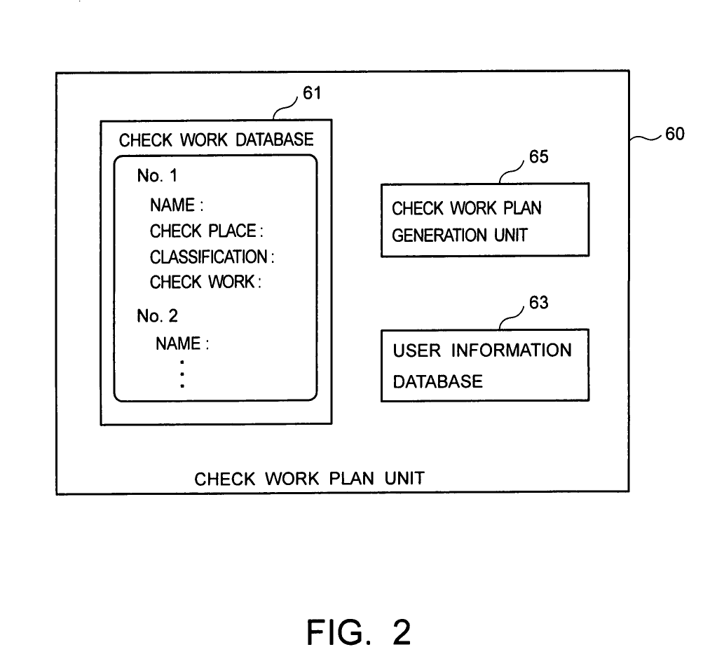

The check work support unit 50 includes a check work plan unit 60 and a work result record unit 70. The check work plan unit 60 generates an execution order of check works based on data stored in a check work database 61 and a user information database 63 shown in FIG. 2. The work result record unit 70 records an execution result of the robot 100 (or the user). For example, the work result record unit 70 stores an image of a check place after execution of the check work.

The check work represents various works (tasks) to be executed indoors in case of the user's going out. For example, check work may include, locking the door for crime prevention, precautions against fire, check of switch off of an electric product, check of leaving a thing in a home, and check of route to a destination. The check work may include the user's check work and the robot's autonomous check work. Furthermore, the check place represents a location to execute the check work indoors. For example, the check place is, a window and a door for locking, a gas implement for precautions against fire, a switch for the electric products, and an umbrella stand for rainy weather. Actually, the check place is represented as a position coordinate (X,Y,Z) recognizable by the robot 100.

FIG. 2 is a schematic diagram of inner components of the check work plan unit 60. The check work plan unit 60 includes a check work database 61, a user information database 63 and a check work plan generation unit 65. The check work database 61 correspondingly stores a check work and a check place to execute the check work. For example, a name of an execution object of the check work, the check place, a classification of the execution object, and contents of the check work, are stored in correspondence with each number (discrimination number). These data are called task data.

The user information database 63 stores discrimination number of task data to be executed for a user, biological data necessary for the user identification, and a schedule of the user in correspondence with each user name (or user identifier). As mentioned-above, the discrimination number is assigned to each task data. The biological data is, for example, a user's facial feature, a fingerprint, or a voice-print. The user identification may not be executed using the biological data and may be executed using an ID, a password and so on.

The check work plan generation unit 65 extracts task data necessary for the user based on information of the user information database 62 from the check work database 61. Furthermore, the check work plan generation unit 65 generates an execution order of the check works based on map information of the control/operation unit 10 in order for the robot 100 to effectively execute the check works. For example, the check work plan generation unit 65 determines the execution order of the check works of which route is the minimum.

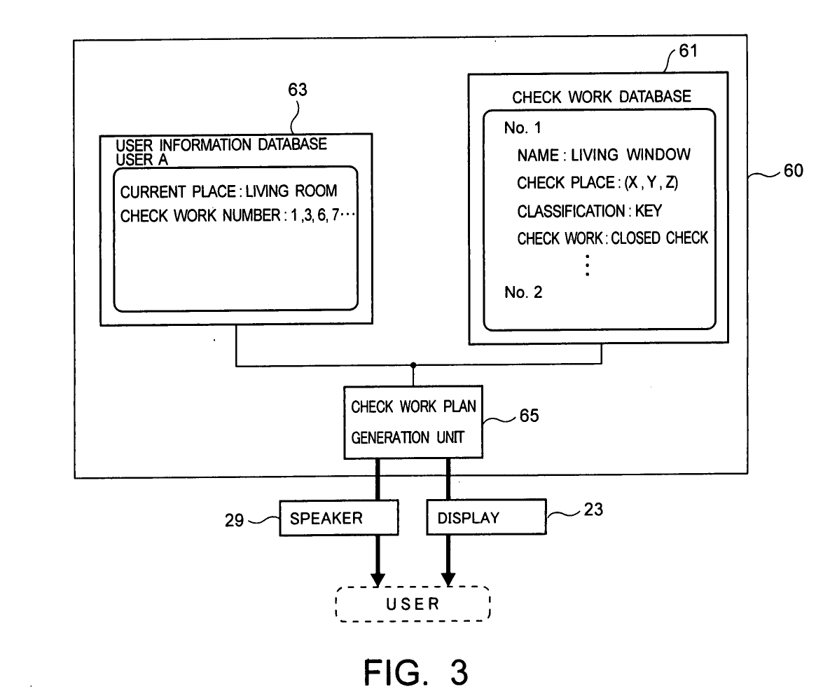

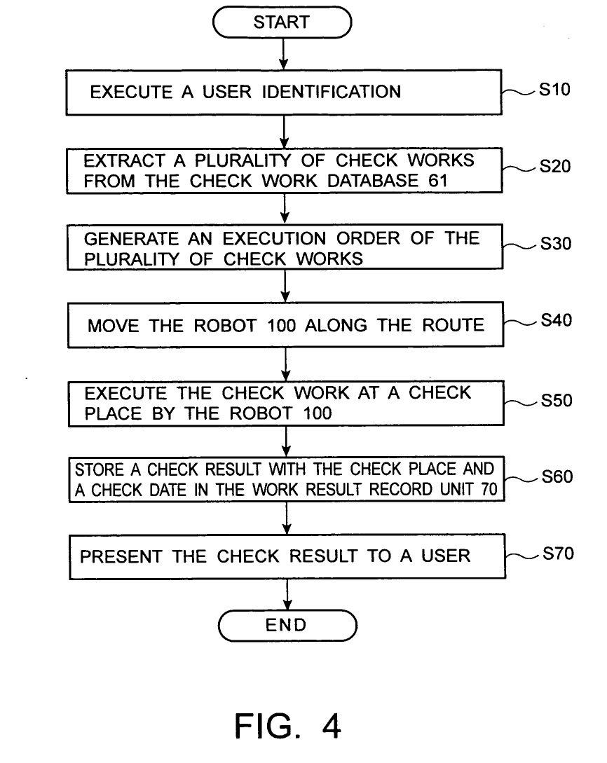

FIG. 3 is a schematic diagram of a concrete operation of the check work plan unit 60 according to the first embodiment. FIG. 4 is a flow chart of processing of the robot control method according to the first embodiment. In the first embodiment, the robot 100 checks lock of the door when a user departs. As mentioned-above, the user information database 63 stores numbers of task data corresponding to each user. The check work database 61 stores a name of a check object (For example, a living room window), a coordinate of the check place, a classification of the check object (For example, a key), and contents of check work (For example, closed check).

First, the robot 100 executes user identification (S10). For example, when a user utters the intention of departing through the microphone 27, the control/operation unit 10 (as an identification unit) executes the user identification by comparing the user's voice with a registered voice-print. If the user is identified as a registered user stored in the user information database 63, the robot 100 begins the check works. The user identification may be executed using biological data other than voice-print.

The check work plan generation unit 65 obtains numbers corresponding to the user from the user information database 63, and extracts task data corresponding to the numbers from the check work database 61 (S20). The check work plan generation unit 65 sets a current location of the robot 100 as a base position when the user's voice is input, and generates an execution order of the check works based on the base position and the map information (S30). In this case, a route from the base position to each check place is generated.

The robot 100 moves along the route (S40). A position of the robot 100 is decided based on a rotation of a gyro or a wheel and the map information. When the robot 100 reaches the check place (X,Y,Z), the robot 100 executes the check work (S50). For example, if a name of the check object is “living room window”, if a classification of the check object is “key” and if the check work is “closed check”, the robot 100 checks whether a key of the living window is locked.

In order to decide whether the key of the living window is locked, the check work database 61 previously stores each image of lock status and unlock status of the living window. The control. operation plan unit 10 (as an image processing unit) compares each image with an input image of actual status of the living window.

The input image is stored with a name of the check place and a check date in the work result record unit 70 (S60). After completing all check works, the robot 100 returns to the base position. The robot 100 identifies the user again, and presents the input image of each check place with the name of the check place and the check date to the user (S70). In this case, the images are displayed in the execution order of check works with the route on the display 23 in order for the user to easily understand. Alternatively, the robot 100 may display an image of unlock window only on the display 23. Furthermore, the robot 100 may output a speech indicating the unlock window through the speaker 29. In this case, the user can know the unlock window only.

The check result (image data and speech data) of check place stored in the work result record unit 70 is presented to the user by the display 23 or the speaker 29 through the communication unit 20. If the user has already gone out, the user's portable terminal accesses the work result record unit 70 by sending a request signal through the network 101. In this case, the user can obtain the image data and/or the speech data as the check result.

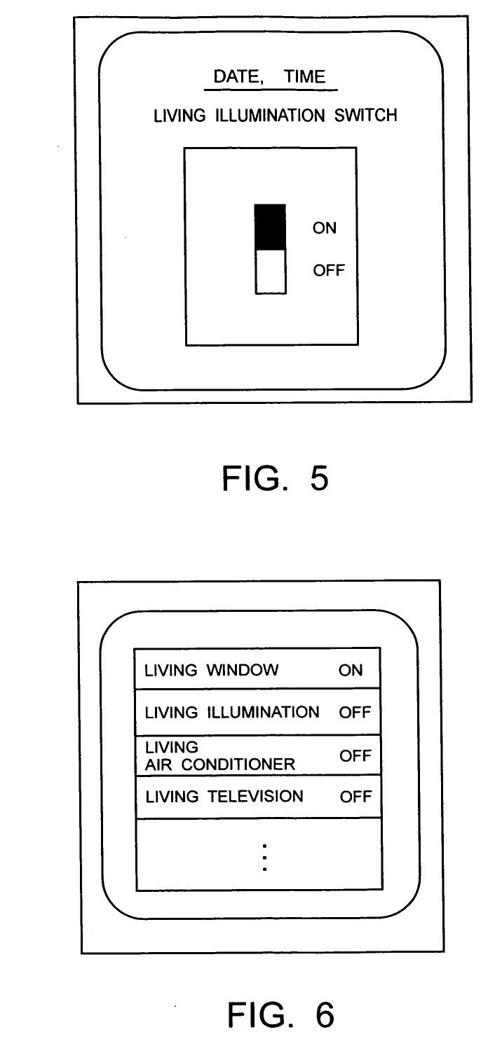

As the check result, as shown in FIG. 5, an image input at the check place is stored with a check object name and a check date (and a check time) in the work result record unit 70. Alternatively, as shown in FIG. 6, the check result may be stored as a list with the check object name in the work result record unit 70. In this case, even if the user has already gone out, the user can refer the check result by accessing the work result record unit 70.

In the first embodiment, the robot 100 automatically decides whether the window is locked. However, without deciding lock status of the window, the robot 100 may present an image of the check object to the user. In this case, the robot 100 need not execute image processing. As a result, the user can check a status (lock or unlock) of the window only by watching the image of the window.

The robot 100 may execute check work with a user. Concretely, the robot 100 goes with the user. After the user checks whether a window is locked at the check place, the user inputs a lock status of the window through the microphone 27 or the touch panel 25. The robot 100 stores the lock status of the check place with the image of the check object in the work result record unit 70.

In this example of the first embodiment, check works relate to a window lock. However, the check works may relate to a gas implement or electric equipment. In the case of a gas implement, for example, a name of check object is gas stove or gas stopcock, a classification of the check object is a stopcock or a switch, and contents of check work is check of turning off the gas. In case of the electric equipment, for example, a name of check object is electric light or electric hotplate, a classification of check object is a switch, and contents of check work is check if switch is off. In the same way as decision of lock status at S50 in FIG. 4, decision of turning on/off or switch on/off may be realized by image comparison processing or the user may actually check.

After the user departs, the robot 100 checks whether the front door is locked. In case of unlocking the front door, the robot 100 immediately informs the user of unlock. Furthermore, the robot 100 may turn off the light locally after the user departs.

After the user departs, the robot 100 may automatically execute check work and update the check result stored in the work result record memory 70 as shown in FIGS. 5 and 6. The robot 100 may execute check work using various sensors for crime prevention and for detection of unusual occurrence.

In the first embodiment, the check work plan generation unit 65 determines the execution order of check works so that a route connecting each check place is the minimum. However, by assigning a priority degree to each task data in the check work database 61, the check work plan generation unit 65 may generate a route to execute each check work in higher order of the priority degree. Furthermore, if a user is busy, the user may execute check works of which priority degree is above a threshold before the user goes out. In this case, after the user goes out, the robot 100 may execute any remaining check works.

As mentioned-above, in the first embodiment, before a user goes out, the robot 100 supports check works to be executed by the user. Accordingly, a crime or a disaster indoors can be previously prevented.

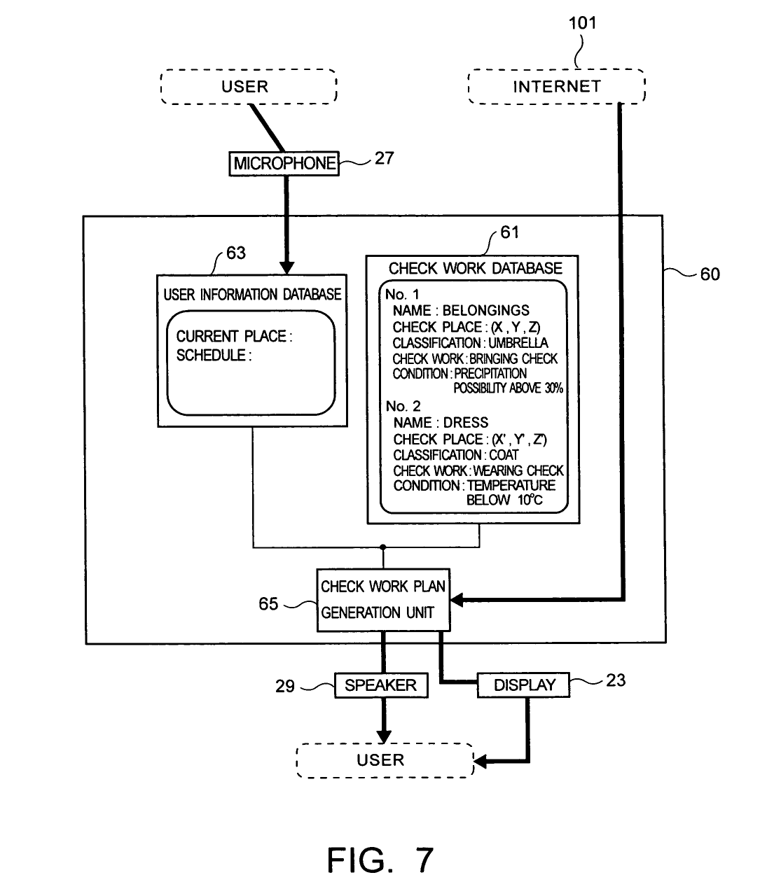

FIG. 7 is a schematic diagram of a concrete example of the check work plan unit 60 according to the second embodiment. In the second embodiment, in case of a user's going out, the robot 100 checks the user's belongings or a route to a destination. Components of the robot 100 of the second embodiment are the same as FIGS. 1 and 2.

In the second embodiment, the user information database 63 stores numbers of task data corresponding to each user, and a schedule of the user. This schedule may be previously registered by the user through the touch panel 25 or may be input by the user though the microphone 27 when the user goes out. The check work database 61 stores a name of check object (For example, belongings), a coordinate of check place, a classification of check object (For example, umbrella), contents of check work (For example, check of bringing), and a condition (For example, precipitation possibility is above 30%). These data are called as task data.

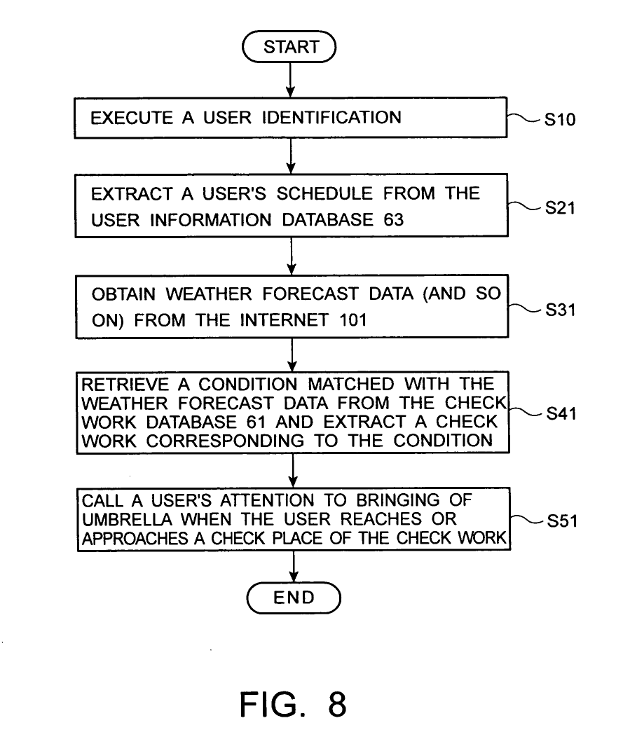

FIG. 8 is a flow chart of processing of the robot control method according to the second embodiment. As shown in FIG. 8, first, the robot 100 executes the user identification (S10). The user identification method is the same as the first embodiment.

The check work plan generation unit 65 obtains the schedule from the user information database 63, and recognizes a date and a destination of the user's going out (S21). Next, the check work plan generation unit 65 obtains a weather forecast and traffic information of the destination at the date from the Internet 101 (S31).

Furthermore, the check work plan generation unit 65 retrieves a condition matched with the weather forecast and the traffic information from the check work database 61, and extracts task data including the condition (S41). For example, if the weather forecast represents that precipitation possibility is above 30%, the check work plan generation unit 65 extracts task data “No. 1” from the check work database 61 in FIG. 7. Furthermore, for example, if the weather forecast represents that temperature is below 10° C., the check work plan generation unit 65 extracts task data “No. 2” from the check work database 61 in FIG. 7.

Next, the robot 100 follows the user. When the user reaches or approaches a check place included in the task data, the robot 100 suitably executes the check work (S51). For example, when the user reaches or approaches a coordinate (X,Y,Z) of the front door, the robot 100 calls the user's attention to bringing of umbrella by speech through the speaker 29. Furthermore, by previously storing an image of the umbrella, the robot 100 may present the image through the display 23. Furthermore, when the user reaches or approaches a coordinate (X′,Y′,Z′) of a closet, the robot 100 calls the user's attention to wearing of coat by speech through the speaker 29. Furthermore, by previously storing an image of the coat, the robot 100 may present the image through the display 23 of the closet.

By internally having a clock counting the time, the check work plan generation unit 65 may decide a season or an hour based on a date or a time of the clock, and may execute check work based on the season or the time. For example, if the check work plan generation unit 65 decides that the season is winter based on the date of the clock, the check work plan generation unit 64 extracts task data “No. 2” from the check work database 61, and the robot 100 calls the user's attention to wearing a coat by speech through the speaker 29. Furthermore, if the check work plan generation unit 65 decides that a current hour is night based on the time of the clock, the robot 100 turns on the electric light indoors.

Furthermore, based on traffic information obtained from the Internet 101, the check work plan generation unit 65 generates a route to the user's destination, and presents the route as a recommended route to the user through the display 23. For example, if the minimum route from the user's current location to the destination is tied up, the robot 100 presents a roundabout way to the user through the display 23. The outdoor map information is previously stored in the check work database 61 or the control/operation plan unit 10. Furthermore, if the minimum route from the user's current location to the destination is tied up, the robot 100 recommends the user to depart early through the speaker 29, and presents a departure time as a recommendation time of the user's going out based on traffic status.

As mentioned-above, in the second embodiment, based on information of the user's destination and the current location of the robot 100 (or the user), the robot 100 presents useful information to the user. Concretely, in case of the user's going out, the user's belongings or a route to the user's destination can be checked.

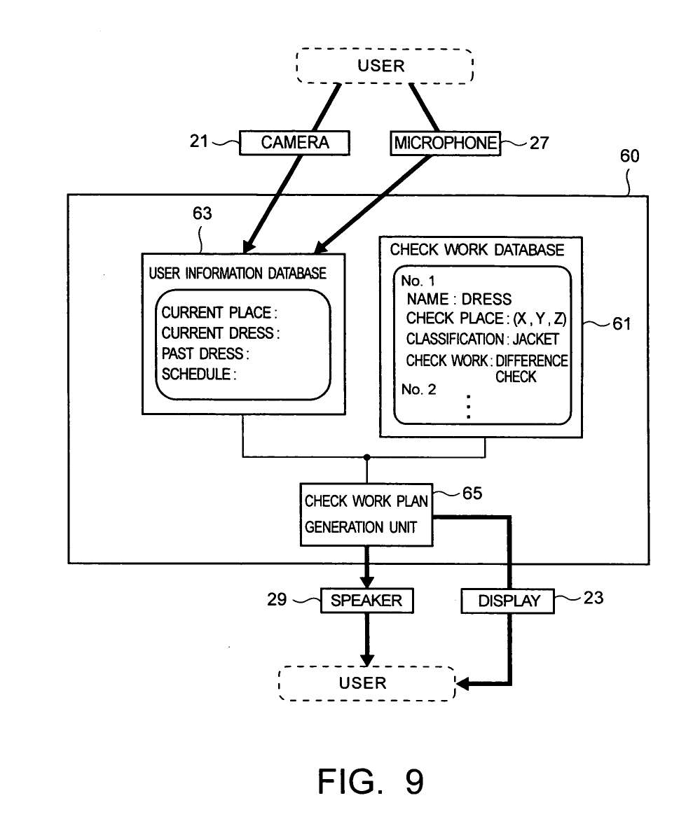

FIG. 9 is a schematic diagram of a concrete example of the check work plan unit 60 according to the third embodiment. In the third embodiment, in case of a user's going out, the robot 100 checks the user's dress. Components of the robot of the third embodiment are the same as in FIGS. 1 and 2.

In the third embodiment, the user information database 63 stores the user's current place (location), the user's current dress, the user's past dress, and the user's schedule. These data may be previously registered by the user through the touch panel 25, or may be input by the user through the microphone 27 when the user goes out. Furthermore, information of the user's present dress and past dress may be image data input by the camera 21. The check work database 61 stores a name of check object (For example, dress), a coordinate of check place, a classification of check object (For example, a jacket), and contents of check work (For example, check of difference).

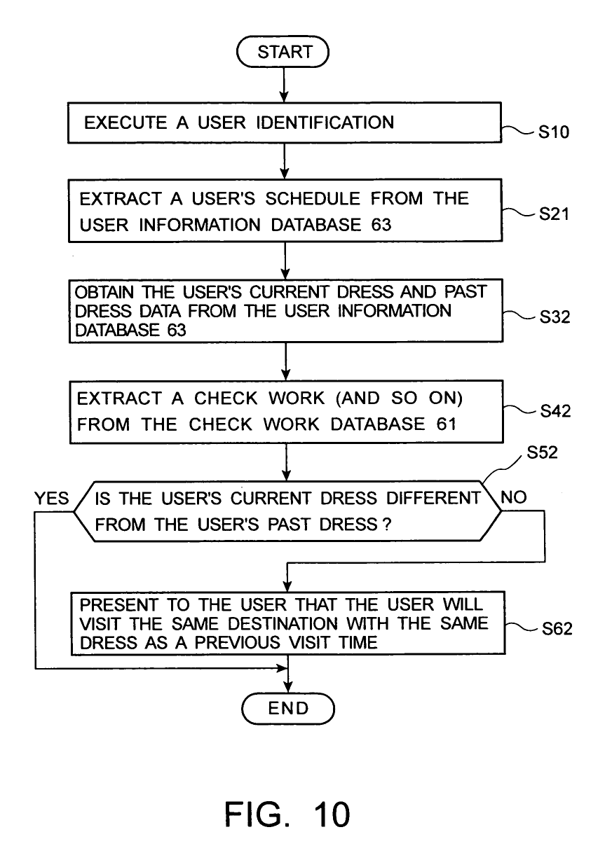

FIG. 10 is a flow chart of processing of the robot control method according to the third embodiment. As shown in FIG. 10, first, the robot 10 executes the user identification (S10). The user identification method is the same as in the first embodiment.

The check work plan generation unit 65 obtains the schedule from the user information database 63, and recognizes a date and a destination of the user's going out from the schedule (S21). Next, the check work plan generation unit 65 obtains the user's current dress and past dress data from the user information database 63 (S32). The past dress data represents a dress worn by the user when the user went to the same destination formerly.

Hereinafter, check work related with a jacket as the dress is explained. In this case, the check work plan generation unit 65 extracts task data including the classification of check object “jacket” from the check work database 61 (S42). Next, the robot 100 follows the user. When the user reaches or approaches a check place included in the task data, the robot 100 suitably executes a check work included in the task data (S52). For example, as the check work, the check work plan generation unit 65 decides whether the user's current dress is different from the user's past dress for the same destination (S52). If these clothing are the same, the robot 100 presents to the user that the user will visit the same destination with the same clothing as a previous visit time through the speaker 29 (S62).

In this way, in the third embodiment, based on the current dress and past dress data, similarity of the user's dress for the same destination is checked. Accordingly, the robot 100 can advise the user not to continually wear the same clothing as yesterday or several days before.

In the second and third embodiments, check work of belongings or clothing may be executed using a wireless tag instead of image processing. For example, the wireless tag is previously set to the belongings or the clothing. By recognizing the wireless tag, the robot 100 checks the user's belongings or the user's dress. Accordingly, the robot 100 can support the user to check the belongings and the dress when the user goes out.

In the disclosed embodiments, the processing can be accomplished by a computer-executable program, and this program can be realized in a computer-readable memory device.

In the embodiments, the memory device, such as a magnetic disk, a floppy disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

1. A robot for autonomously moving locally, comprising:
a move mechanism configured to move said robot;
a check work memory configured to store a plurality of check works and check places to execute each check work in case of a user's departure;
a check work plan unit configured to select check works to be executed from said check work memory and to generate an execution order of selected check works;
a control unit configured to control said move mechanism to move said robot to a check place to execute a selected check work according to the execution order;
a work result record unit configured to record an execution result of each of the selected check works; and
a presentation unit configured to present the execution result to the user.

2. The robot according to claim 1,
wherein said check work memory stores a plurality of task data each corresponding to a discrimination number, each task data including contents of the check work, a location of the check place, a name of an object of the check work, and a classification of the object.

3. The robot according to claim 2,
further comprising a user information memory configured to store discrimination numbers of the task data corresponding to each user.

4. The robot according to claim 3,
wherein said check work plan unit identifies the user, and extracts the discrimination numbers of the identified user from said user information memory.

5. The robot according to claim 4,
wherein said check work plan unit selects the task data corresponding to the extracted discrimination numbers, and generates the execution order of the selected task data so that a route connecting each check place included in the selected task data is the minimum.

6. The robot according to claim 5,
further comprising a camera configured to input an image of the object at the check place whenever said robot reaches each check place.

7. The robot according to claim 6,
wherein said work result record unit correspondingly records the image, the name of the object, and a date of execution of the check work; and
wherein said presentation unit displays the image with the name of the object and the date.

8. The robot according to claim 6,
further comprising an image processing unit configured to recognize a status of the object at the check place; and
wherein said presentation unit calls the user's attention based on the status.

9. The robot according to claim 1,
wherein said presentation unit presents the execution result of each check work with the moving route in the execution order.

10. The robot according to claim 3,
wherein the task data includes a condition to execute the check work,
wherein said user information memory includes a schedule of the user.

11. The robot according to claim 10,
further comprising an interface configured to communicate with a network, and
wherein said check work plan unit extracts a date and a destination of the user's departure from the schedule, obtains outside information matched with the date and the destination from the network through said interface, and selects the task data including the condition matched with the outside information from said check work memory.

12. The robot according to claim 11,
wherein said check work plan unit calls the user's attention to the classification of the object included in the selected task data when the user reaches or approaches the place included in the selected task data.

13. The robot according to claim 10,
wherein said check work plan unit includes a clock, decides a season or a time for execution of check work based on the clock, and selects the task data including the condition matched with the season or the time.

14. The robot according to claim 11,
wherein said check work plan unit generates a recommended route from the user's current location to the destination or a recommendation departure time for the user based on the outside information, the date, and the destination.

15. The robot according to claim 10,
wherein said user information memory stores a current clothing status and a past clothing status of the user, and
wherein said check work plan unit obtains the current clothing status and the past clothing status based on the schedule from said user information memory, and selects the task data related with a clothing status from said check work memory.

16. The robot according to claim 15,
wherein said check work plan unit decides whether the current clothing status is the same as the past clothing status, and presents to the user that the user will visit with the same clothing as a previous time if the current clothing status is the same as the past clothing status.

17. The robot according to claim 11,
wherein said control unit controls said move mechanism to move said robot to the check place to execute each of the selected check works according to the execution order after the user departs.

18. The robot according to claim 17,
wherein said check work plan unit sends the execution result of each of the selected check works to the network through said interface in response to a request from a portable terminal.

19. A method for controlling a robot, comprising:
storing a plurality of check works and check places to execute each check work locally in case of a user's departure in a memory;
selecting check works to be executed from the memory;
generating an execution order of selected check works;
moving the robot to a check place to execute a selected check work according to the execution order;
recording an execution result of each of the selected check works; and
presenting the execution result to the user.

20. A computer program product, comprising:
a computer readable program code embodied in said product for causing a computer to control a robot, said computer readable program code comprising:
a first program code to store a plurality of check works and check places to execute each check work locally in case of a user's departure in a memory;
a second program code to select check works to be executed from the memory;
a third program code to generate an execution order of selected check works;
a fourth program code to move the robot to a check place to execute a selected check work according to the execution order;
a fifth program code to record an execution result of each of the selected check works; and
a sixth program code to present the execution result to the user.
